(19) United States
(12) Patent Application Publication
(10) Pub. No.: US 2015/0240869 A1
(43) Pub. Date: Aug. 27, 2015

(54) Liquid Metal Journal Bearing

(71) Applicants: Christoph Dummert, Erlangen (DE); Wolfgang Schäff, Burgthann (DE)

(72) Inventors: Christoph Dummert, Erlangen (DE); Wolfgang Schäff, Burgthann (DE)

(21) Appl. No.: 14/619,264

(22) Filed: Feb. 11, 2015

(30) Foreign Application Priority Data
Feb. 26, 2014 (DE) 102014203430.2

(51) Int. Cl. F16C 32/06; H01J 35/10

(52) U.S. Cl. CPC F16C 32/0633; H01J 35/101; H01J 2235/08

(57) ABSTRACT

The embodiments relate to a liquid metal journal bearing including at least one first bearing part and at least one second bearing part. The bearing parts are non-positively connected to one another. Additionally, at least one sealing ring made of a ductile material is arranged between the first bearing part and the second bearing part. With a liquid metal journal bearing of this type, the escape of liquid metal is prevented, even under heavy loading. The liquid metal journal bearing is therefore suitable, for example, for installation in an X-ray generator.

### CROSS-REFERENCE TO RELATED APPLICATIONS

This application claims the benefit of DE 10 2014 203 430.2, filed on Feb. 26, 2014, which is hereby incorporated by reference in its entirety.

### TECHNICAL FIELD

The embodiments relate to a liquid metal journal bearing.

### BACKGROUND

Liquid metal journal bearings operate almost wear-free but run very smoothly and also generate very little noise, while providing effective heat dissipation. Liquid metal journal bearings of this type are therefore used, for example, in rotating anode X-ray tubes, particularly high power X-ray tubes.

For this purpose, the journal bearing surfaces of the liquid metal journal bearing has a high level of heat resistance and good heat conduction capacity. Furthermore, the journal bearing surfaces has a good wetting capability. Materials based on molybdenum may be used as the materials for the liquid metal journal bearings. Particular steels and ceramics are also used as materials for liquid metal journal bearings.

A liquid metal journal bearing includes a plurality of components that are ground into one another. In the case of a rotating anode X-ray tube, the liquid metal journal bearing includes, for example, an inner bearing that forms an axle, a sleeve and at least one cover. In order that the liquid metal serving as the lubricant remains within the liquid metal journal bearing and does not escape into the X-ray tube, the components of the journal bearing remain permanently firmly joined. For this purpose, connecting elements, (e.g., screws), are normally used that have a thermal expansion matched to the bearing material so that the pre-loading forces are retained even at the higher service temperatures.

Since the demands placed on rotating anode X-ray tubes are constantly increasing, the attempt is made, inter alia, by increasing the anode rotation speeds, to match up to the growing thermal loads in the focal spot region. At least 12,000 revolutions per minute (200 Hz) may be achieved with rotating anodes.

Due to the high anode rotation speeds, a hydrostatic pressure forms in the liquid metal journal bearing that, depending on the geometry and the actual rotary speed, may be 15 bar or more at the sealing sites of the liquid metal journal bearing. Under unfavorable conditions, this high pressure may have the result that the liquid metal journal bearing becomes leaky and the liquid metal escapes. Such an escape of liquid metal leads to a failure of the X-ray tube and thus to a failure of the X-ray generator. The reason for failure may be a blockage of the liquid metal journal bearing due to a lack of lubrication between the bearing parts. The X-ray tube may also lose its high voltage strength due to the liquid metal entering the vacuum housing. Furthermore, it may negatively influence the quality of the X-ray images.

A variety of measures for providing the necessary sealing in liquid metal journal bearings are known.

One known measure is the welding of the connecting sites. Since molybdenum may not be welded using normal welding methods, welding rings are soldered onto the molybdenum components that are to be welded. Since, at a raised temperature, the liquid metal attacks many metals (e.g., solder and/or welding ring), the components concerned are provided with anti-wetting layers. This measure is firstly technically very complex and secondly is relatively fault-prone.

A further method for realizing sufficient sealing of a liquid metal journal bearing lies in keeping the sealing gap between the components as small as possible. This requires highly precise mechanical machining of the opposing sealing surfaces in order to generate the lowest possible surface roughness and therefore a high degree of flatness. Methods used for this are fine grinding, fine turning or lapping (e.g., chip-producing manufacturing methods). However, highly precise machining alone is not sufficient for adequate sealing. In addition, the methods have the disadvantage that the quality achievable for the surfaces is highly dependent on the material properties of the components, the tools used (e.g., quality and degree of wear) and on the grinding materials as well as on the processing personnel. The measure is therefore subject to relatively large variations in the quality achievable.

Finally, the sealing of a liquid metal journal bearing may be improved by optimizing the screw fixing. This may be carried out, for example, by increasing the pressure in the components to be joined, for example, through an increase in the number of screws or larger dimensioning of the screws or by reducing the coefficient of friction between the screws and the corresponding bores in the components to be joined by vacuum-proof lubricants.

In DE 195 23 162 A1, a liquid metal journal bearing is described wherein an anti-wetting coating of metal oxide is applied to the surfaces of the bearing parts made of molybdenum, particularly aluminium (III) oxide (Al₂O₃) or titanium (IV) oxide (TiO₂). The coating of the sealing surfaces is carried out by a PVD (physical vapor deposition) method.

The layer thicknesses realizable thereby lie between approximately 0.1 μm and approximately 1 μm. Even at the maximum possible layer thickness, it is not possible to cover the rough surface of the bearing parts (e.g., mean roughness Rₐ approximately 2 μm) completely. It is also not possible to planarize the rough molybdenum surface by PVD methods.

The aluminium oxide or titanium oxide coatings applied to the surface of the bearing parts are relatively hard so that no “interlocking” of surfaces pressed against one another is possible. This has the result that with increasing loading of the liquid metal journal bearing (e.g., higher rotary speeds, higher temperatures), increasingly low manufacturing tolerances (e.g., less than 2 μm) are maintained so that the PVD coatings applied withstand the increasing pressure of the liquid metal, e.g., prevent an escape of the liquid metal.

Due to the high vapor deposition rate during coating (e.g., short process time) and the “granularity” of the vapor deposition material (e.g., granulate or spherules of Al₂0₃ with an approximately 1 mm diameter), during vapor deposition by an electron beam, small “spherules” are released from the evaporation material, which then remain adhering to the surface of the bearing parts. Even during pressing together of the bearing parts, no change is visible with such spherules. This is due, firstly, to the gap that is actually present between the bearing parts (larger than the diameter of most of the spherules) and, secondly, to the hardness of the aluminum oxide, so that disadvantageously, a larger gap is formed at the sealing surfaces than is provided by the flatness of the bearing parts.

From EP 0 685 871 B1, a titanium acetyl acetonate alcohol solution (TiAcAc) is applied onto the surface of a bearing component followed by a subsequent heat treatment to make a coating of titanium(IV) oxide (TiO₂). If the surfaces of the components that form the sealing surface are only imprecisely processed, however, the aforementioned coating process is insufficient for satisfactory sealing. Furthermore, the coating processes place great demands on the cleanliness of the surfaces involved and are highly sensitive with regard to the process parameters.

In addition, DE 196 06 871 C2 discloses a liquid metal journal bearing wherein a sealing material forms a solid mixed phase with the liquid metal, which has a sealing effect.

However, the measures described often are not sufficient alone to provide reliably the sealing tightness in a liquid metal journal bearing.

### SUMMARY AND DESCRIPTION

The scope of the present invention is defined solely by the appended claims and is not affected to any degree by the statements within this summary. The present embodiments may obviate one or more of the drawbacks or limitations in the related art.

It is therefore an object of the present embodiments to provide a liquid metal journal bearing, wherein an escape of liquid metal is reliably prevented, even under high loading.

The liquid metal journal bearing includes at least one first bearing part and at least one second bearing part that are non-positively connected to one another. At least one sealing ring made of a ductile material is arranged between the first bearing part and the second bearing part.

With the liquid metal journal bearing, at least one sealing ring made of a ductile material is arranged between the first bearing part and the second bearing part, even under heavy loading. In other words, particularly under high pressures and/or high temperatures, a liquid metal escape from the liquid metal journal bearing is reliably prevented. The liquid metal journal bearing is therefore suitable, for example, for installation in an X-ray generator. The sealing effect is not impaired by a changing load generated by the drive (e.g., an anode drive) or by temperature variations; therefore also no deposition effects arise in the ductile material.

The ductile sealing ring may be placed either on the first bearing part or on the second bearing part before the joining of the two bearing parts. Following the joining of the first bearing part and the second bearing part, the two bearing parts have only to be screwed onto one another.

In that the seal in the liquid metal journal bearing is designed as a sealing ring, a functional separation of the sealing effect and the force transmission is reliably provided, since although the sealing effect extends over the whole periphery, it takes place only locally and not over the whole cross-section.

Furthermore, the ductile material of which the sealing ring is made is significantly more economical in comparison, for example, with metallic or ceramic coatings or metal seals. Furthermore, liquid metal journal bearings in which the sealing tightness diminishes, may be refurbished.

The gap between the bearing parts of the liquid metal journal bearing that arises during assembly and results from the unavoidable manufacturing tolerances, is at least significantly reduced or even eliminated. In this way, the manufacturing of a liquid metal journal bearing is significantly accelerated and simplified since, during the manufacturing of the bearing parts, small manufacturing tolerances may be tolerated. This results in a corresponding reduction of the manufacturing costs.

A particularly embodiment of the liquid metal journal bearing is characterized in that the sealing ring is arranged in a first groove that extends in the first bearing part.

According to a further advantageous exemplary embodiment of the liquid metal journal bearing, the sealing ring is arranged in a second groove that extends in the second bearing part.

In certain embodiments, a first groove and/or a second groove are provided, where the functional separation of the sealing effect and the force transmission is further improved. A liquid metal journal bearing configured thus may be still more heavily loaded thermally and/or mechanically.

The groove, which has a depth that is smaller than the height of the sealing ring may be arranged either in one of the two bearing parts, in the first bearing part or, in the second bearing part. It is also possible that a first groove is arranged in the first bearing part and a second groove in the second bearing part. If the first groove and the second groove are arranged coincident with one another, then the first groove and the second groove each have a partial depth, e.g., two equal-sized depths wherein it may be noted that the total of the two depths is smaller than the height of the sealing ring.

Alternatively or additionally to a groove, a cutting ring may be arranged on the first bearing part and/or on the second bearing part. The relevant cutting ring (cutting edge) extends on the side that faces the respective other bearing part. During the screwing together of the two contacting bearing parts, the cutting ring becomes buried in the ductile material and thereby leads to corresponding sealing. In particular, with a combination of at least one groove in which a sealing ring is inserted and at least one cutting ring that is arranged opposing the groove and which becomes buried in the sealing ring, a still better sealing of the liquid metal journal bearing is obtained.

Where two sealing rings are used, for example, the cutting ring may also be arranged radially within or radially outside the groove. One of the two sealing rings is then arranged, for example, in the groove and the other sealing ring corresponds with the cutting ring.

The groove or grooves may be designed such that the sealing ring is compressed by the connecting elements (e.g., screws) by a defined value (e.g., by 40%) on assembly of the liquid metal journal bearing. Thus a pre-tension may be sustained in all operating states of the liquid metal journal bearing.

In an advantageous embodiment, the sealing ring has a rectangular cross-section.

In a further embodiment, the ductile material of the sealing ring is graphite. Graphite does not react with liquid metal to form a compound, nor does it dissolve and is not wetted by the liquid metal. Thus liquid metal is not lost or alloyed. Furthermore, graphite is stable up to high temperatures and does not evaporate and is thus vacuum-suitable. Thus, the liquid metal journal bearing is particularly good for use in an X-ray generator.

The X-ray generator includes a generator housing in which an X-ray tube with a vacuum housing and a drive motor is arranged, wherein a cathode and a rotating anode are arranged in the vacuum housing and the rotating anode is held rotationally fixed on a rotor shaft that is coupled to the drive motor. The rotor shaft is rotatably mounted by at least one liquid metal journal bearing as described above.

### BRIEF DESCRIPTION OF THE DRAWINGS

FIG. 1 depicts a first embodiment of a liquid metal journal bearing.

FIG. 2 depicts a second embodiment of a liquid metal journal bearing.

FIG. 3 depicts a third embodiment of a liquid metal journal bearing.

### DETAILED DESCRIPTION

The liquid metal journal bearing includes at least one first bearing part 1 and at least one second bearing part 2 that are non-positively connected to one another. At least one sealing ring 3 made of a ductile material is arranged between the first bearing part 1 and the second bearing part 2.

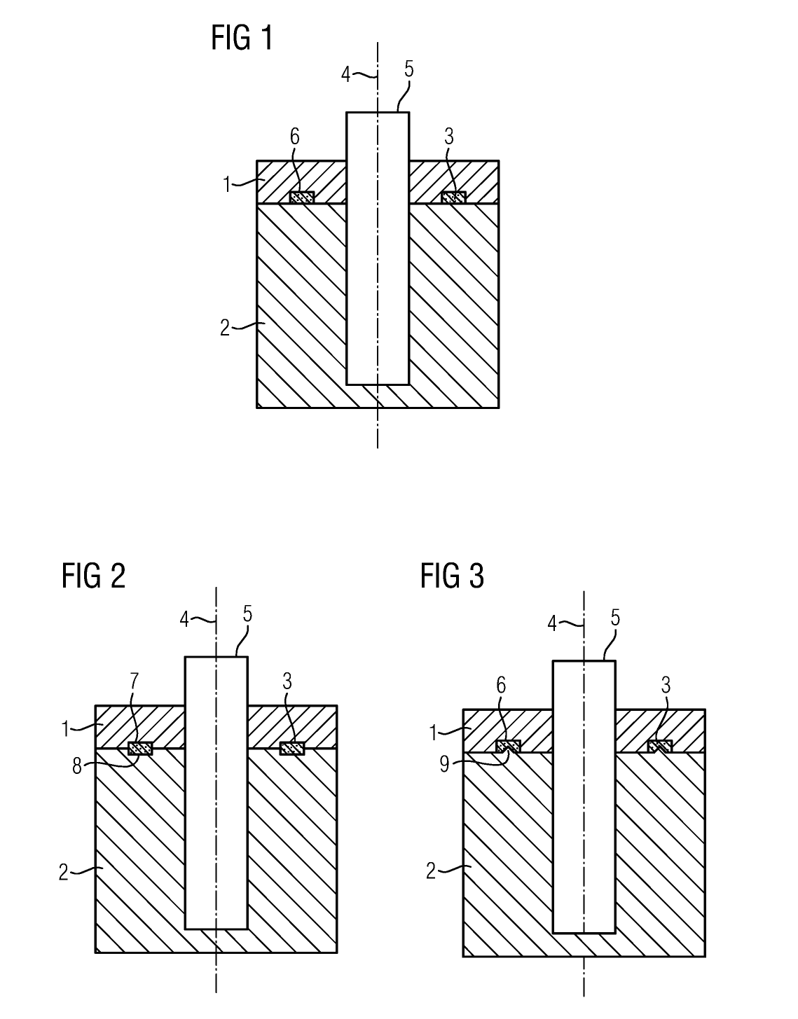

The liquid metal journal bearing depicted in the exemplary embodiments according to FIGS. 1 to 3 includes exactly one first bearing part 1 and exactly one second bearing part 2, wherein a single sealing ring 3 made of a ductile material, (e.g., graphite), is arranged between the first bearing part 1 and the second bearing part 2. In each case, the sealing ring 3 has a rectangular cross-section and is arranged concentrically with a longitudinal axis 4 of an axle 5. In the exemplary embodiments depicted, the first bearing part 1 and the second bearing part 2 are configured as rotatable bearing parts.

A plurality of sealing rings may also be arranged between the first bearing part 1 and the second bearing part 2. Furthermore, the liquid metal journal bearing may also include a plurality of first bearing parts and a plurality of second bearing parts.

In the exemplary embodiment according to FIG. 1, the sealing ring 3 is arranged in a first groove 6 that extends in the first bearing part 1. The ductile material of the sealing ring 3, which has a rectangular cross-section is graphite in the embodiment depicted.

In order to achieve good sealing, the depth of the first groove 6 is less than the height of the sealing ring 3. The sealing ring 3 is compressed by the connecting elements (e.g., screws) by a defined value (e.g., by 40%) on assembly of the liquid metal journal bearing. Thus, a pre-tension may be sustained in all operating states of the liquid metal journal bearing.

In the exemplary embodiment according to FIG. 2, a first groove 7 is arranged in the first bearing part 1 and a second groove 8 is arranged in the second bearing part 2. The first groove 7 and the second groove 8 are arranged coincident with one another and each have a smaller depth than the groove 6 in the liquid metal journal bearing according to FIG. 1, wherein the total of the two depths is smaller than the height of the sealing ring. In this embodiment, the sealing ring 3 is again compressed by the connecting elements (e.g., screws) by a defined value on assembly of the liquid metal journal bearing.

In the embodiment according to FIG. 3, the first bearing part 1 again includes a first groove 6. A cutting ring 9 that extends on the side facing toward the first bearing part 1 and extends opposing the first groove 6 is arranged on the second bearing part 2. Again, a sealing ring 3 is laid in the first groove 6. On assembly of the liquid metal journal bearing, the cutting ring 9 becomes embedded in the sealing ring 3. In this embodiment, a yet further improved sealing of the liquid metal journal bearing is obtained.

Although the invention has been illustrated and described in detail based on the exemplary embodiments, the invention is not restricted by the exemplary embodiments depicted in FIGS. 1 to 3. Rather, a person skilled in the art may derive therefrom other variants of the solution without thereby departing from the underlying concept.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A liquid metal journal bearing comprising:
at least one first bearing part; and
at least one second bearing part,
wherein the first bearing part and the second bearing part are non-positively connected to one another, and
wherein at least one sealing ring made of a ductile material is arranged between the first bearing part and the second bearing part.

2. The liquid metal journal bearing as claimed in claim 1, wherein the sealing ring is arranged in a first groove that extends in the first bearing part.

3. The liquid metal journal bearing as claimed in claim 2, wherein the first groove has a depth that is smaller than a height of the sealing ring.

4. The liquid metal journal bearing as claimed in claim 3, wherein a cutting ring is arranged on the first bearing part, the cutting ring extending on a first bearing part side facing toward the second bearing part.

5. The liquid metal journal bearing as claimed in claim 4, wherein the cutting ring is arranged on the second bearing part, the cutting ring extending on a second bearing part side facing toward the first bearing part.

6. The liquid metal journal bearing as claimed in claim 2, wherein the sealing ring is arranged in a second groove that extends in the second bearing part.

7. The liquid metal journal bearing as claimed in claim 6, wherein the second groove has a depth that is smaller than a height of the sealing ring.

8. The liquid metal journal bearing as claimed in claim 7, wherein a cutting ring is arranged on the first bearing part, the cutting ring extending on a first bearing part side facing toward the second bearing part.

9. The liquid metal journal bearing as claimed in claim 8, wherein a cutting ring is arranged on the second bearing part, the cutting ring extending on a second bearing part side facing toward the first bearing part.

10. The liquid metal journal bearing as claimed in claim 1, wherein a cutting ring is arranged on the first bearing part, the cutting ring extending on a first bearing part side facing toward the second bearing part.

11. The liquid metal journal bearing as claimed in claim 10, wherein a cutting ring is arranged on the second bearing part, the cutting ring extending on a second bearing part side facing toward the first bearing part.

12. The liquid metal journal bearing as claimed in claim 1, wherein the sealing ring has a rectangular cross-section.

13. The liquid metal journal bearing as claimed in claim 1, wherein the ductile material of the sealing ring is graphite.

14. An X-ray generator comprising:
a generator housing in which an X-ray tube with a vacuum housing and a drive motor is arranged,
wherein a cathode and a rotating anode are arranged in the vacuum housing,
wherein the rotating anode is held rotationally fixed on a rotor shaft coupled to the drive motor,
wherein the rotor shaft is rotatably mounted by at least one liquid metal journal bearing, the metal journal bearing comprising:
at least one first bearing part; and
at least one second bearing part,
wherein the first bearing part and the second bearing part are non-positively connected to one another, and
wherein at least one sealing ring made of a ductile material is arranged between the first bearing part and the second bearing part.

15. The X-ray generator as claimed in claim 14, wherein the sealing ring is arranged in a first groove that extends in the first bearing part, wherein the first groove has a depth that is smaller than a height of the sealing ring.

16. The X-ray generator as claimed in claim 15, wherein a cutting ring is arranged on the first bearing part, the cutting ring extending on a first bearing part side facing toward the second bearing part.

17. The X-ray generator as claimed in claim 16, wherein the cutting ring is arranged on the second bearing part, the cutting ring extending on a second bearing part side facing toward the first bearing part.

18. The X-ray generator as claimed in claim 15, wherein the sealing ring is arranged in a second groove that extends in the second bearing part, wherein the second groove has a depth that is smaller than a height of the sealing ring.

19. The X-ray generator as claimed in claim 18, wherein a cutting ring is arranged on the first bearing part, the cutting ring extending on a first bearing part side facing toward the second bearing part.

20. The X-ray generator as claimed in claim 19, wherein a cutting ring is arranged on the second bearing part, the cutting ring extending on a second bearing part side facing toward the first bearing part.
